(19) United States
(12) Patent Application Publication
(10) Pub. No.: US 2017/0006356 A1
(43) Pub. Date: Jan. 5, 2017

(54) AUGMENTED EXPERIENCE OF MEDIA PRESENTATION EVENTS

(71) Applicant: Microsoft Corporation, Redmond, WA (US)

(72) Inventor: Georgios Krasadakis, Dublin (IE)

(73) Assignee: MICROSOFT CORPORATION, Redmond, WA (US)

(21) Appl. No.: 14/788,845

(22) Filed: Jul. 1, 2015

(51) Int. Cl. H04N 21/81; H04N 21/439; G10L 15/22; G10L 15/18; H04N 21/2668; H04N 21/258; H04N 21/45; H04N 21/4788; H04N 21/41; H04N 21/2187; G10L 17/00

(52) U.S. Cl. CPC H04N 21/8133; H04N 21/2187; H04N 21/4394; G10L 15/22; G10L 15/18; G10L 17/005; H04N 21/25891; H04N 21/4532; H04N 21/4788; H04N 21/4126; H04N 21/2668

(57) ABSTRACT

Architecture that provides an augmented user experience with a smooth, enriched, and personalized information flow during a live competitive event such as a sports game or non-live media presentations. A user having a user device with the application components installed can experience an automatic synchronization of content with the entities, activities, and moments occurring in live match being watched. This is achieved through logic applied on a combination of different inputs and entities/activities/moments continuously identified based on at least natural language processing technologies. The user experience associated with media presentation of the event on a first user device is augmented by the automatic identification of a live match, the teams, stadium, players, etc., and generation/presentation of highly related content on a second user device with which the user is currently interacting.

### BACKGROUND

Typical coverage of a live competitive event such as affiliated with sports, focuses (and is limited) on live broadcasting and commentating. It can be shown that increasing percentages of users watching a live match on television also use a companion smart device (e.g., tablet, mobile phone, laptop, etc.) to search for additional data within the context of the live match. This can apply equally to non-live media events such as movies and television programs. Thus, it is a distraction for users who then devote attention and time to search, browse and select related web content as part of viewing such events.

### SUMMARY

The following presents a simplified summary in order to provide a basic understanding of some novel implementations described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables an automated flow of complementary information (content) while viewing a media presentation, whether a live event or a non-live event. For example, if a live sporting event (or game), while the user enjoys the live broadcast on a television, additional content can be generated and presented on another user device (e.g., a device the user is currently holding or interacting with tactilely or proximately using non-tactile gestures), such as facts, statistics, and content about the live event and also the entities associated with the live event.

The disclosed architecture can be realized using one or more client applications and a server infrastructure, where the one or more client applications communicate with the server infrastructure and enable the unattended (e.g., free of user input) identification of entities (e.g., people, teams, sports, leagues, places, things, etc.) as these entities are being mentioned by the commentator of the event, the synthesis of the most appropriate package of content to be served to the user, the unattended identification of a commentator based on speech patterns, the unattended identification of the live event the user is watching (or listening to), the continuous multi-stage optimization of content sets, and a distributed quality-based model for entity extraction.

The set of content is automatically generated and served to the user, as the next “best” mix of content for the protagonist (e.g., the player(s), the actor, the singer, etc.—depending on the class of the event), as associated with a moment (defined as a point in time associated with the event, or as an occurrence as part of the event) and/or other entities. In the context of a game, for example, the content mix can refer to a player, but can also, or alternatively, describe additional entities such as the team, the stadium, the league, the referee, etc. The content mix can be synthesized dynamically for a given moment in time or the moment (action) itself, which is a process triggered by event moments (e.g., moments occurring during the event) identified in a real-time fashion.

The architecture provides an augmented user experience with a smooth, enriched, and personalized information flow during a live competitive event such as a sports game or other forms of live/non-live media presentation such as movies and videos, video clips, audio files, audio clips, etc. A user having a user device with the application components installed can experience a seamless synchronization with the live match being watched. This is achieved through logic applied on a combination of different inputs and entities continuously extracted based on natural language processing (NLP) technologies (e.g., on verbal or textual commentary). The user simply enables the user device in an operating mode and the rest of identification of a match being presented on another device, the identification of the match itself, the sport, the league, the teams, stadium, players, etc., all occur automatically and seamlessly. An always-on mode is also supported where the user activates the application on the device once, and then the identification of what the user is watching happens automatically and with no user input (unattended).

Given that this seamless synchronization is established, the architecture enhances (augments) the user experience by extending the information provided by typical live game coverage, with social, biographical, news, statistics, and related content including articles, news, photos, videos, audio, social posts, and more. Users can be served with an optimized content mix that combines many different types of content. Optimized content is content that is computed to be highly relevant (e.g., uses a statistical score and a threshold to determine relevance) to the moment, the moment in time, the user, etc., for the given media presentation (live or non-live event). In the context of the media presentation being a sporting event, optimization can be attained within the game, between games (or matches within a game), etc., using trend analysis and baselines, using single user content consumption patterns, etc. Similarly, in the context of the media presentation being a non-live event such as a movie, optimization can be attained within the movie, between movies or segments (e.g., intermission) of the same movie, etc., using trend analysis and baselines, using single user content consumption patterns, and so on.

Within each session (where a session can be defined as a continuous segment of time that encompasses all related activities/presentations of an event from start to finish, including pre-event media, media during the event, and post-event media), the user is being served with multiple content packages (mixes) as synthesized according to the protagonist (e.g., player, athlete, actor, singer, etc., depending on the class of the event) of each major moment in the game/event (e.g., a goal, a free-kick, a penalty, etc.).

The mix of the content package can also depend on the type of the moment, the significance of the moment, the running score, the importance of the game/event, and more. The sequence of content packages as mapped with the moments of the game/event, is then visualized on the game/event timeline (the timeline can also act as a time-navigation element allowing the user to browse the content served throughout the game/event, by selecting a specific moment). Additionally, the final augmented game/event timeline is accessible and sharable through the application clients and also via the web.

Optimal sets of mixed content can be synthesized through a continuous optimization process which takes into consideration what content is already being served to the specific user, the engagement levels of the user on specific types of content as well as global patterns associating certain types of content with specific user profiles and event/match occasions.

The architecture comprises a distributed quality-based model for entity extraction. In general, assuming n users all watching the same live event, the entity extraction process is driven by the top users/sessions in terms of entity extraction quality. Rather than trying to identify the events (and players, etc.) from a user's noisy environment, the quality-based model subscribes to the higher-quality listener/results from other users/sessions consuming the same live event. The architecture then uses the higher-quality results on content identification to drive the content generation for one or more other users (based on the events identified)

Entity extraction quality operates to deliver the highest quality information for the given environment, where for example, the environment encompasses those users with the highest sound quality from their TV, the closest distance to their TV, the less in-room noise, and so on.

Consider an example for a local user and other remote users all watching the same live event. Since the quality of the listening process/entity extraction for each user is quantified as some value, the architecture looks for a significantly better value among the remote users, and if there is such a value among the remote users, uses the higher-quality results associated with that value; otherwise, the results of the local user are used.

The entity extraction process for live events (also referred to as entity identification) can be optimized through the re-use of higher quality sessions of other online users. Consider an example of two users, a User A using higher quality equipment than a second user, User B, who is using lower-quality equipment.

For example, assume that User A is watching Match A and has a higher quality television (TV) presenting the live match, an increased volume level from the TV, and also holds a higher-quality tablet device with one or more higher-quality microphones. Assume also that User A is alone, and thus, there is no further noise in the room. These can be considered ideal conditions for the architecture presented herein to listen and identify what is going on within the live game (i.e., the listening-identification process will generate results of high-confidence (and quality)).

Consider also that concurrently with what is occurring with User A, User B experiences the same live match through a lower-quality configuration (e.g., lower-quality TV speakers, low volume, noisy environment, lower-quality tablet/microphones, the user is simply seated a greater distance from the TV set, or a combination thereof). User B will experience a lower level of confidence with possibly some gaps (no relevant content generated and presented, or no content generated at all) and even poor entity identification.

The architecture addresses this situation by using the information that both User A and User B are watching the same live match: since the User A configuration produces higher quality entity identification, the architecture uses User A identification results to drive content generation for User B. The actual content delivered to User B can still be different from the content delivered to User A due to further personalization.

As soon as the architecture uses User A to also drive the content experience of User B, the identification component associated with User B is reduced (in capability from (a) ensuring the match event is being identified and (b) the moments/entities are identified as they occur, down to only (a), since (b) uses a higher-quality source) to ensure that User B is still watching the same match. This is a scalable, high-performance technique to optimize the identification process for live events.

As a generalization, the architecture can also combine higher-quality sessions to fill gaps, make corrections, and create the best possible identification results for the specific live event. This top quality identification result set is used to serve all users watching the specific match, thus significantly improving user experience and information flow.

The architecture enables companion applications for sport events, for example, which can significantly increase user engagement, trigger social impact activity (e.g., one-click sharing of the information displayed), and generate new monetization opportunities (e.g., localized advertisements during breaks, sponsors of the game, sports, leagues, etc.).

In a more general description of the architecture as applied to sporting events, as a user watches a live sporting event on the television (or a radio, a laptop, or similar device), the disclosed client application is capable of understanding if the user is watching a sporting event, the specific sporting event being watched, if the sporting event is live or not, the stadium, the sport to which the event refers, the league, the teams playing and team synthesis, the type of moments/activities defined for the specific sport (e.g., a goal, a free kick for soccer, or a shot, rebound for basketball, etc.) and the related terminology, and event metadata such as, duration, sport-related terminology, etc.

During the (live) match/event description, the client application can identify each specific moment/activity class (e.g., a goal, free kick, penalty, etc., in the context of a soccer game as the media presentation), and also identify the involved players and the affected team. Each moment/activity instance (which can combine activity type, players, team, for example) triggers a process of synthesizing an optimal metadata package, which comprises an additional, non-standard package of information for the player and/or team (e.g., can be a combination of player biography, recent news, popular social posts, historical win/loss records, statistics, career, etc.).

As users watch the live sporting event, the user device(s) seamlessly (without interaction by the user and without disruption of the media presentation) synchronizes and presents the highly-related package of content and metadata in a near realtime fashion and according to an optimized timing effect. The optimized timing effect is realized by the generation and presentation of the appropriate or relevant content at or in close temporal proximity (e.g., sub-second or seconds) to the time the associated moment occurs in the media presentation (e.g., live sporting event).

The overall experience is also optimized for the specific user through a continuous, multi-stage optimization process which continuously optimizes (personalizes) the content package being delivered to the specific user, across the timeline of the match being watched, and also across other matches being watched by the same user.

More specifically, consider that a new user is using the application—for the first time—and the user is watching a match which is automatically identified as a soccer match. In this initial state, the system has no information about the user preferences and content consumption patterns. In order to compile the most suitable package (mix) of content to the user and for the specific moment of the game being watched, the system can use engagement patterns from other users who have watched similar events, in the same market/area, and also taking into consideration the teams/players involved.

As soon as this first package of content is served to the user, the system knows what is being served and the user reaction to that content (e.g., viewed, shared, clicked, saved, discarded, ignored, etc.) and the exact level of engagement associated with specific types of event moments/activities. This knowledge enables the system to gradually improve each subsequent content package to be served to the specific user (while enriching the global knowledge base with user-content interaction patterns) and engagement statistics.

Continuing with the above example, assume there is a new moment/activity in the event/game that involves the same player/team. The system synthesizes a new content package (which excludes some or all content that has already been presented to the user) focusing on what the user seems to enjoy most (e.g., social network messaging and social network comments rather than articles, statistics and news). In this way, the system applies an adaptive ‘trial-and-error’ approach which implicitly captures the preferences of each user.

In the “voice input” scenario, the client application “listens” to the person or persons describing the sporting event, and identifies the sporting event itself, the player names, significant activities/moments in the context of the sport (e.g., goal, penalty, etc.), and then performs text matching, applies a background search, and presents a highly-related synthesis of statistics, information, and content to the user, on a different user device.

In the live commentary scenario, the client application can apply natural language processing on the live commentary feed, again performing entity extraction and metadata retrieval (e.g., voice and live commentary inputs can be handled in parallel to provide additional accuracy and flexibility). The combination uses both sources of live match event information in order to deliver the most appropriate and timely user experience.

The architecture can be applied to media presentations that are non-live events, as well. For example, a user can watch a pre-recorded program on a television or other media presentation device, the audio signals of which can be recognized and processed to identify the program and actors speaking at any moment in time, recognize advertisements, and so on, all of which enable the unattended generation and presentation of content on another device of the user while the program is playing.

In one implementation, the disclosed architecture can be implemented as a system, comprising: an event identification component configured to listen and identify, from at least one of voice or textual signals of a media presentation, a sporting event and entities associated with the sporting event, as covered by the media presentation which is part of an event-watching experience for a user on a first user device; a content generation component configured to generate sets of mixed content related to the sporting event, the entities, specific moments/activities of the event and implicitly derived user preferences, and to synchronize the sets of mixed content with corresponding activities occurring as part of the sporting event, notable moments of the sporting event, and the entities of the sporting event; and, an augmentation component configured to augment the event-watching experience of the media presentation with the sets of mixed content on a second user device via which the user is currently interacting.

In another implementation, the disclosed architecture can be implemented as a method, comprising acts of: identifying entities, activities, and moments of a media presentation of a competitive event on a first device as part of an event-watching experience, the entities, activities, and moments identified based in part on audio signals received as part of the media presentation; generating sets of content related to identified entities, activities, and moments, of the competitive event; and, augmenting the event-watching experience by presenting the sets of content on a second user device via which the user is currently interacting.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system that enables an augmented experience of media presentation events in accordance with the disclosed architecture.

FIG. 2 illustrates an alternative system that enables an augmented experience of media presentation events in accordance with the disclosed architecture.

FIG. 3 illustrates an alternative augmented user experience system in accordance with the disclosed architecture.

FIG. 4 illustrates a server-side system of resources that enable the augmented experience in accordance with the disclosed architecture.

FIG. 5 illustrates a method of processing entity matches in accordance with the disclosed architecture.

FIG. 6 illustrates an alternative method of processing entity matches in accordance with the disclosed architecture.

FIG. 7 illustrates an alternative method in accordance with the disclosed architecture.

FIG. 8 illustrates a block diagram of a computing system that executes an augmented experience of media presentation events in accordance with the disclosed architecture.

### DETAILED DESCRIPTION

The disclosed architecture enables an automated flow of complementary information (content) on a second device while viewing a media presentation on a first device, whether a live event or a non-live event. For example, if a live sporting event (or game), while the user enjoys the live broadcast on a television, additional content can be generated and presented on another user device (a device the user is currently holding or interacting with), such as facts, statistics, photos, social posts, articles, etc., regarding people associated with the live event/game and the specific moments/activities of it.

The architecture can be realized using one or more client applications and server-side processing that enable the unattended (free of user input) identification of entities, the unattended identification of a commentator based on speech patterns, the unattended identification of the live game the user is watching, the synthesis of the most appropriate package of content to be served to the user, the continuous, multi-stage optimization of content sets, and a distributed, quality-based model for entity extraction (described in greater detail herein below).

More generally, the architecture enables the automatic identification of a live sporting match with limited or no direct input from the user; automatically identifies a commentator of the sporting event using natural language processing (NLP) and speech pattern analysis; synchronizes multiple devices and identifies the device user is holding or currently interacting with (via user gestures and/or motion detection); automatically identifies in-room users discussions during the live match and captures sentiment levels on the match, thereby generating insights about the audience; automatically identifies the teams, players, referees, and other important entities, depending on the sport; continuously identifies moments/activities within the game/event timeframe such as kicks, penalties, etc., all sport-specific; and, estimates the importance of each event across several adjustment levels (e.g., sports, game, market, season specific, etc.).

The architecture further enables the identification of important moments/activities in the game and also the “hero of the moment”, the protagonist(s) of the moment (e.g., players, referee, coach, etc.); synthesizes the most appropriate content for the specific user, and for the specific moment (through a range of data sources and channels effectively combined for each specific user); continuously adapts to implicit and/or explicit user preferences and behaviors; serves the next best experience to the user (e.g., unique content packages for the user, within the session); aligns the content served to the timeline of the game, and post-game experience (content combined with in-match moments/activities and emotions captured from the network of users watching the game); enables users to join virtual rooms with friends, to share comments and emotions, all of which are aligned in a single match timeline; a distributed, quality-based model for entity extraction; and, continuous, multi-stage content-mix optimization, all of which are described in detail herein below.

User interaction with the user device can be gesture-enabled, whereby the user employs one or more gestures for interaction. For example, the gestures can be natural user interface (NUI) gestures. NUI may be defined as any interface technology that enables a user to interact with a device in a “natural” manner, free from artificial constraints imposed by input devices such as mice, keyboards, remote controls, and the like. Examples of NUI methods include those methods that employ gestures, broadly defined herein to include, but not limited to, tactile and non-tactile interfaces such as speech recognition, touch recognition, facial recognition, stylus recognition, air gestures (e.g., hand poses and movements and other body/appendage motions/poses), head and eye tracking, voice and speech utterances, and machine learning related at least to vision, speech, voice, pose, and touch data, for example.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems (e.g., HoloLens™, by Microsoft Corporation, which is a head-mounted computer having a display that uses holographic lenses and spatial sound, as well as other capabilities), all of which provide a more natural user interface, as well as technologies for sensing brain activity using electric field sensing electrodes (e.g., electro-encephalograph (EEG)) and other neuro-biofeedback methods.

The disclosed architecture exhibits the technical effects of improved user efficiency and enjoyment when viewing media presentations whether live or played from media such as optical disks, flash drives, magnetic media, and so on.

Reference is now made to the drawings, wherein like reference numerals are used to refer to like elements throughout. In the following description, for purposes of explanation, numerous specific details are set forth in order to provide a thorough understanding thereof. It may be evident, however, that the novel implementations can be practiced without these specific details. In other instances, well known structures and devices are shown in block diagram form in order to facilitate a description thereof. The intention is to cover all modifications, equivalents, and alternatives falling within the spirit and scope of the claimed subject matter.

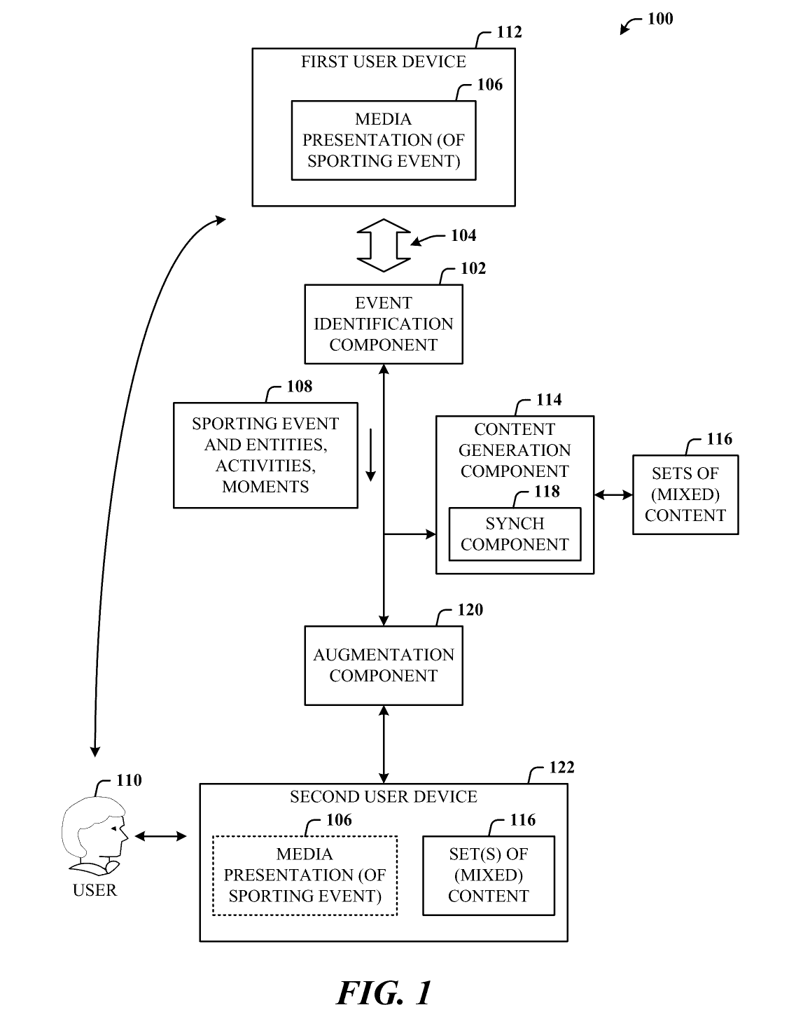

FIG. 1 illustrates a system 100 that enables an augmented experience of media presentation event in accordance with the disclosed architecture. The system 100 can include an event identification component 102 configured to listen to and identify, from at least one of voice/speech or textual signals 104 (e.g., wired and/or wirelessly received) of a media presentation 106, a sporting event, and entities, activities, and moments 108 associated with the sporting event (e.g., a competitive event, whether involving physical activity or otherwise). The media presentation 106 of the sporting event is part of an event-watching (or purely listening) experience for a user 110, which can occur using one or more user media presentation devices such as smart phones, tablet computers, laptop computers, desktop computers, analog and/or digital televisions, and the like (e.g., on a first user device 112).

The event-perceiving (e.g., listening, watching) experience of the user (or users) encompasses many forms of user perception of the media presentation, whether a live feed event or non-live media presentation (e.g., from a recorded media), as well as presentation on possibly multiple user devices, such as a digital television and other digital devices (e.g., tablets and other (portable) media presentation devices), and in one or more location (e.g., rooms, floors) of the building/house individually or concurrently.

A content generation component 114 can be provided and configured to generate sets of mixed content 116 (e.g., any or all forms/types and combinations of media such as text, image, video, audio, documents, links to documents, social posts, articles, etc.) related to the sporting event, the entities, and implicitly identified user preferences (e.g., as determined via user interactions with existing or past content served) and/or explicitly indicated user preferences (e.g., user-defined profiles, user-selected options/preferences, etc.). For example, in terms of a “set of mixed content”, “mixed content” can mean the same types (e.g., all text or all images) or different types of content (e.g., mixture of text, image, animation, audio, etc.), and different content descriptions (what the content is intended to convey), which can include a short animation (e.g., animated clip of a team mascot, broadcast station identity animations, etc.), textual content (e.g., statistics of team and entities, score, league standings, time, etc.), colorized graphics (e.g., team colors, leagues colors, etc.), advertisements, short audio tracks of specific broadcast stations, best moments compilation, etc.

A synchronization component 118 can be provided and configured to synchronize the sets of mixed content 116 with corresponding activities occurring as part of the sporting event, notable moments (e.g., significant plays, penalties, etc.) of the sporting event, and the entities of the sporting event. In other words, as a particular activity is occurring during the media presentation, such as a kicking activity, for example, the sets of mixed content 116 generated and presented can include kicking statistics for any one or more of the team, league, player making the kick, etc. The synchronization component 118 can be designed as part of the logic/functionality of the content generation component 114. Content generation is triggered by specific instances of the entities, as mentioned by the commentator or the textual feed (e.g., players, athletes, actors, singers etc.), activities, and/or moments identified as part of the event. Hence, operational aspects of the synchronization component 118 may be more suitable as part of the content generation/optimization experience.

The content generation and synchronization processes can be performed according to a just-in-time approach, where the content package is generated and synchronized for presentation only as needed and in close time proximity to the presentation of the entity, activity, or moment. This can be an efficient implementation that then will not unnecessarily expend the resources well in advance of the actual time for presenting the content package.

An augmentation component 120 can be provided and configured to augment (supplement) the event-watching experience of the media presentation 106 with the sets of mixed content 116 on a second user device 122 via which the user 110 is currently interacting (e.g., holding, in close proximity to, communicating with using voice commands and other user gestures, etc.). The second user device 122 is shown as presenting the media presentation 106 circumscribed by a dotted-line block, which indicates an optional presentation, since the sets of mixed content 116 can be presented alone on the second user device 122 or in combination with the media presentation 106.

The event identification component 102 can be configured to perform natural language processing on speech/voice audio signals (of the signals 104) and speech pattern analysis on speech/voice signals of the media presentation 106 of the sporting event. The event identification component 102 can also be configured to perform entity recognition processing of textual and/or visual content (e.g., textual content and coloration identities typically overlayed on the video and that relate to the team, such as team names, event location, team colors, advertisements, etc.) of the media presentation 106 to identify the entities. The event identification component 102 can also be configured to identify participants in the sporting event, such as team members, team coaches, team owners, referees, etc. The event identification component 102 can also be configured to identify commentator(s) of the sporting event. The identification of the commentator is desirable since this enables the architecture to separate (differentiate) commentator speech/voice from other persons possibly in the room. Doing so, the architecture can focus on commentator's speech, analyze words against its knowledge base and derive additional information that includes the sport, the league, the participants, player and game statistics, player and game moments, significant plays that occur during the sporting event and can be considered to impact the outcome of the sporting event.

It is additionally within contemplation of the disclosed architecture that the identification of third-party entities such as people, businesses, advertisers, advertisements, and so on, and recognition of live textual commentary by the third-party, can be obtained. This third-party identification and textual information can further provide a source of additional information from which to identify the event, entities, activities, and moments of the event or more generally, the media presentation.

The content generation component 114 can be configured to also access user display history as relates to the sporting event and also to the overall content consumption pattern for the user-across a wide range of sport events and choose a next best set of mixed content to be served as complementary to the media presentation to the second user device based on user content consumption patterns (what was presented and inferred that the user accepted or liked) and history. When a user device is served with content and the media presentation, these actions (e.g., display history) can be traced, as well as the user interactions with the served content and the particular media presentation (included live and non-live media). For example, click-through actions on specific instances of content can be identified and stored as part of the history for the user. It can also be the case that the time the content is synchronized for a given sporting event entity, activity, and moment (e.g., a time out) can be logged not only for the media presentation as a whole but also for a given user. This enables subsequent retrieval of the log for post-event review or even rewind of the log to a specific point in time while the event is occurring.

The history can also include the particular user devices utilized during the specific sporting event and when a given user device was used during the sporting event. For example, the user may choose to use a device with a larger display (e.g., laptop) during a halftime presentation, but then use a different device (e.g., a tablet) when gameplay resumes. This user behavior can then be logged and analyzed for future content selections.

The disclosed architecture finds applicability to radio station broadcasts, where only audio signals are communicated. For example, while traveling in a vehicle and listening to a live radio broadcast of a football game, a tablet computer with mobile communications and display capability can be employed to listen and analyze the audio stream locally (in the vehicle), generate content via the cellular communications network, and download the sets of content to the tablet computer in synchronism with the events occurring as identified in the audio signals.

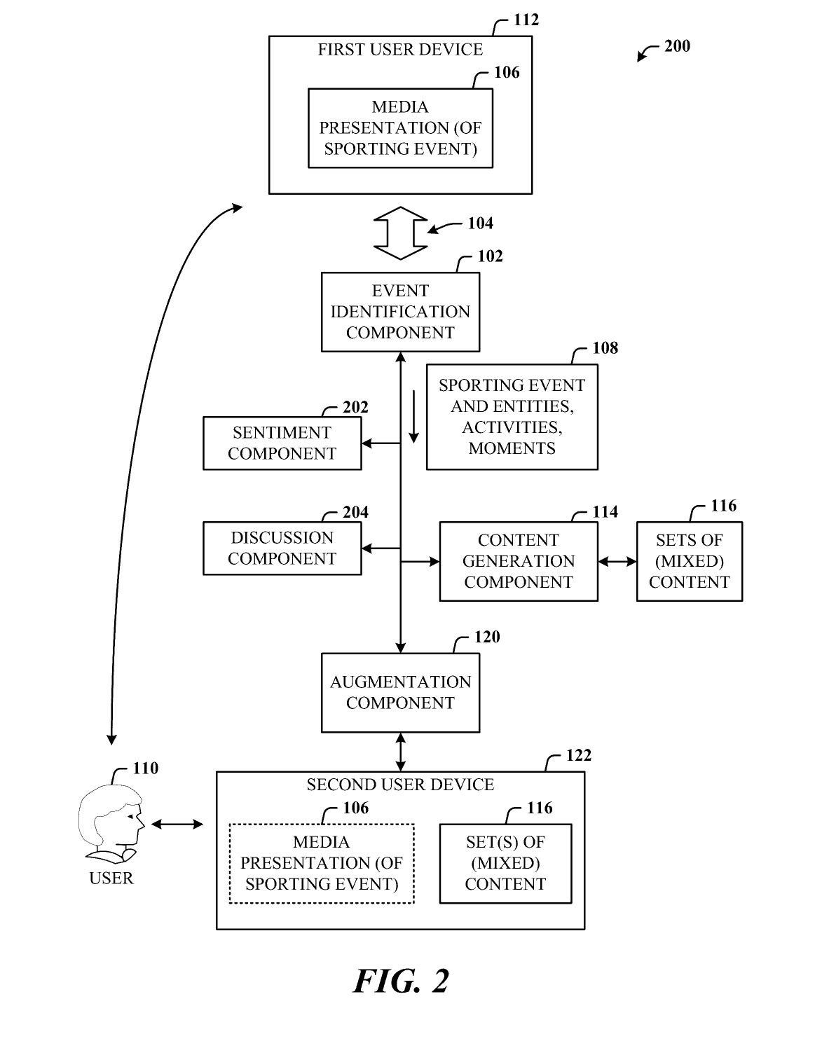

FIG. 2 illustrates an alternative system 200 that enables an augmented experience of media presentation events in accordance with the disclosed architecture. The system 200 includes the components and functionality of system 100 of FIG. 1, and additionally, a sentiment component 202 and a discussion component 204.

The sentiment component 202 can be provided and configured to capture user sentiment as relates not only to event activities, entities, and moments, but also to live discussions (e.g., of announcers, players, coaches, commentators, etc.), for example, of the moments/activities occurring as part of the sporting event. Moreover, user sentiment can be captured via user interactions to the sets of content presented, via textual analysis of user messages exchanged during the media presentation, by way of audio capture (e.g., microphones) and recognition of user speech as part of conversations of the users, by video capture locally of user gestures and actions (e.g., facial expressions, arm movements, body movements, finger movements, etc.), via user click-through activity on the content presented, and so on.

The discussion component 204 can be provided and configured to generate virtual rooms (e.g., computer-enable virtual environments for chat communications and/or face-to-face video communications) and enable access to the virtual rooms for discussions related to the sporting event (e.g., the entities, activities, and moments, etc.). A virtual room can be established locally and restricted only to users at the location (e.g., in the home) from which the media presentation (event) is being viewed.

Alternatively, one or more virtual rooms can be established on an external network and restricted by certain topics as relate to the media presentation, such as for example, post-game discussion, game analysis, actor discussion (e.g., for movies, televised programs, etc.), and so on. It is to be understood that any number and kind of restrictions and authorizations can be employed to access and manage the virtual rooms. As another example, a virtual room can be restricted only to those people who actually watched or listened to the sporting event. Similarly, a virtual room can be restricted only to those people who actually watched or listened to a given media presentation (e.g., a program, movie, etc.) played in a predetermined time period (e.g., the last week, the most recent episode, a given episode, etc.). Other criteria can be applied as desired.

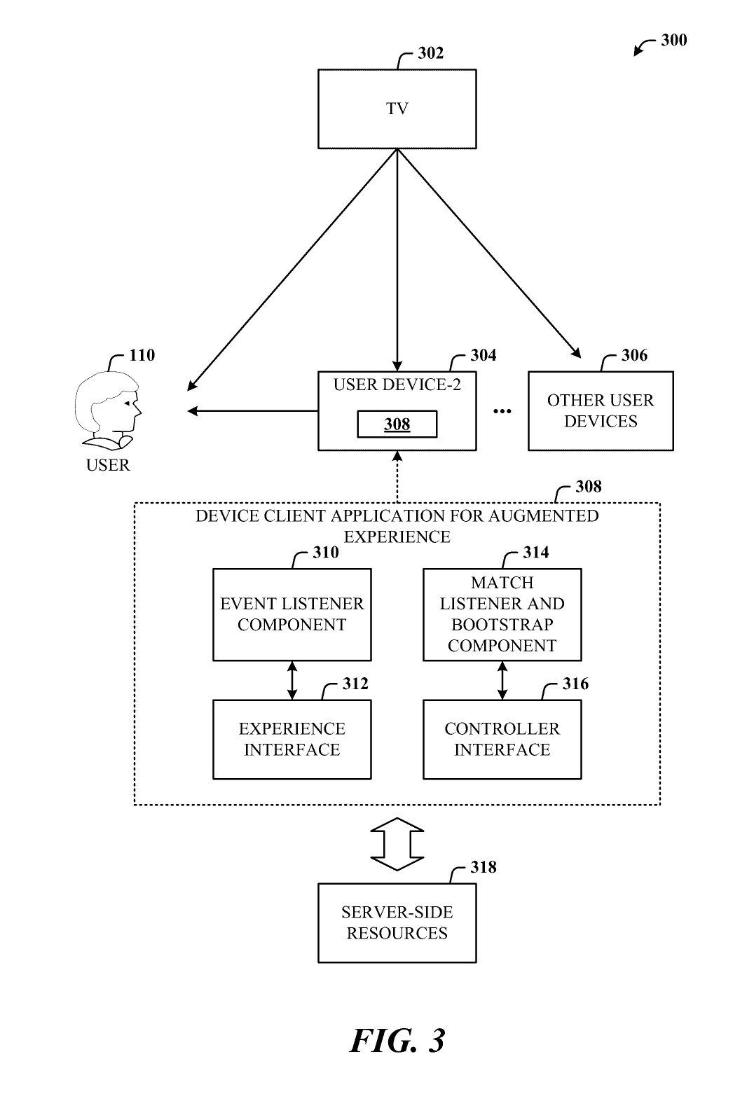

FIG. 3 illustrates an alternative augmented user experience system 300 in accordance with the disclosed architecture. In this system 300, the user 110 is watching and listening to a media presentation (live or non-live) on a television 302 (e.g., analog, digital, etc.), which is similar to the first user device 112 of FIG. 1. Associated with the user 110 and to enable the augmented experience, can be a second user device 304 (similar to second user device 122 of FIG. 1), and possibly, one or more other user devices 306 (e.g., smart phones, smart watches, Hololens™, virtual reality devices, wearable devices, tablet computers, laptop computers, desktop computers, legacy devices that connect to the cloud to employ cloud services and resources (e.g., hardware, software, etc.)).

The television 302 is playing the media presentation (e.g., live sporting event, replay of the sporting event, movie, weekly program, etc.) by displaying the media presentation as images and/or videos, while outputting audio signals, such as voice, and music, and also presenting content (e.g., advertisements, commercials, sporting event overlay content, movie overlay content (e.g., annotations, etc.). As the user perceives these signals by watching and listening to the media presentation, the second user device 304 receives and recognition processes the audio signals. In yet another implementation, the second user device 304 can include a camera that enables the capture and recognition processing of the video and content displayed on the television 302.

As depicted, the second user device 304 includes a client application 308 which enables the augmented user experience in accordance with the disclosed architecture. The client application 308 is described in terms related to watching and listening to a live sporting event; however, it is to be understood that the system 300 applies equally to non-sports events, and also to non-live media presentations such as replays of sporting events, movies, plays, concerts etc. The client application 308 can include at least an event listener and processor component 310, an experience interface 312 (e.g., an API—application program interface), a match listener and bootstrap component 314, and a controller interface 316 (e.g., API).

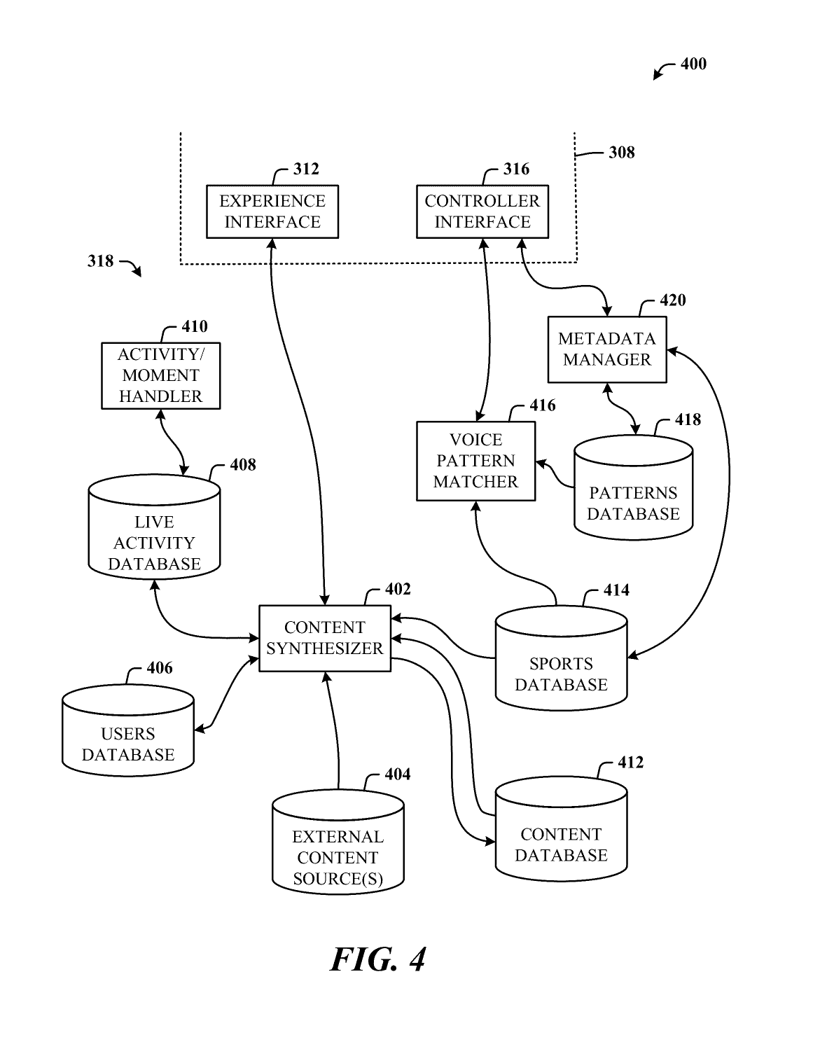

FIG. 4 illustrates a system 400 of the server-side resources 318 that enable the augmented experience in accordance with the disclosed architecture. The system 400 shows that the experience interface 312 and controller interface 316 of the client application 308 provide the primary interfaces to the server-side resources 318 that include the external content sources (e.g., websites, databases, social networks, user stores, etc.).

More specifically, the experience interface 312 interfaces to a content synthesizer 402, which is an engine that synthesizes the most appropriate content for each user and for each moment/activity in the game/event. The content synthesizer 402 interfaces to external content source(s) 404 (e.g., search engines and public content providers (e.g., Bing™, Google™, Yahoo™, Youtube™, Wikipedia™, etc.) and/or licensed content sources), users database(s) 406 (e.g., a database of user interactions), and a live activity database 408 (e.g., a database of activities that can be performed in the live game).

A moment/activity handler 410 also interfaces to the live activity database 408. The handler 410 is a component that registers activities and moments, and maintains the most accurate, high-quality, and complete version of each activity/moment for each match. The handler 410 replies (answers) to requests for activity/moment information retrieval.

The content synthesizer 402 also interfaces to a content database 412 and a sports database 414 (a registry database of sports information). In addition to, or alternatively from, accessing content of the external content sources 404, the content synthesizer 402 sends requests and receives content from the content database 412. The content synthesizer 402 also interfaces to the sports database 414 to retrieve sports information for use as content for presentation in association with the entities, activities, and moments to augment the user experience.

A voice pattern matcher 416 interfaces to the controller interface 316, as well as to the sports database 414 and a patterns database 418. The patterns database 418 is a knowledge base of voice patterns as relate to commonly known commentators or other sports entities, as well as new instances of such entities as are learned and organized against market, language, event class (sport, entertainment), categories, channels etc.).

A metadata manager 420 is provided and configured to handle and maintain ontology models and analytical information on how games are organized across sports, the involved entities, structural components, named entities, etc. The metadata manager 420 interfaces to the patterns database 418 and the controller interface 316. This enables the relationships to be established between the human entities, entity speech patterns, and sports which these patterns and entities are associated.

It is to be understood that in the disclosed architecture, certain components may be rearranged, combined, omitted, and additional components may be included. Additionally, in some implementations, all or some of the components are present on the client, while in other implementations some components may reside on a server or are provided by a local or remote service.

For example, in FIG. 1, the event identification component 102 and augmentation component 120 can reside on the second user device 122, while the content generation component 114 (and hence, the synchronization component 118) can reside in the cloud. In another example, all of the components (102, 114, 116, 118, and 120) all reside on the second user device 122. As to be appreciated, other combinations can be employed where desired for the particular devices used and implementations.

The disclosed architecture can optionally include a privacy component (not shown) that enables the user to opt in or opt out of exposing personal information as can relate to the user selections of content, media presentation, and/or devices, for example. The privacy component enables the authorized and secure handling of user information, such as tracking information, as well as personal information that may have been obtained, is maintained, and/or is accessible. The user can be provided with notice of the collection of portions of the personal information and the opportunity to opt-in or opt-out of the collection process. Consent can take several forms. Opt-in consent can impose on the user to take an affirmative action before the data is collected. Alternatively, opt-out consent can impose on the user to take an affirmative action to prevent the collection of data before that data is collected.

Included herein is a set of flowcharts representative of exemplary methodologies for performing novel aspects of the disclosed architecture. While, for purposes of simplicity of explanation, the one or more methodologies shown herein, for example, in the form of a flowchart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

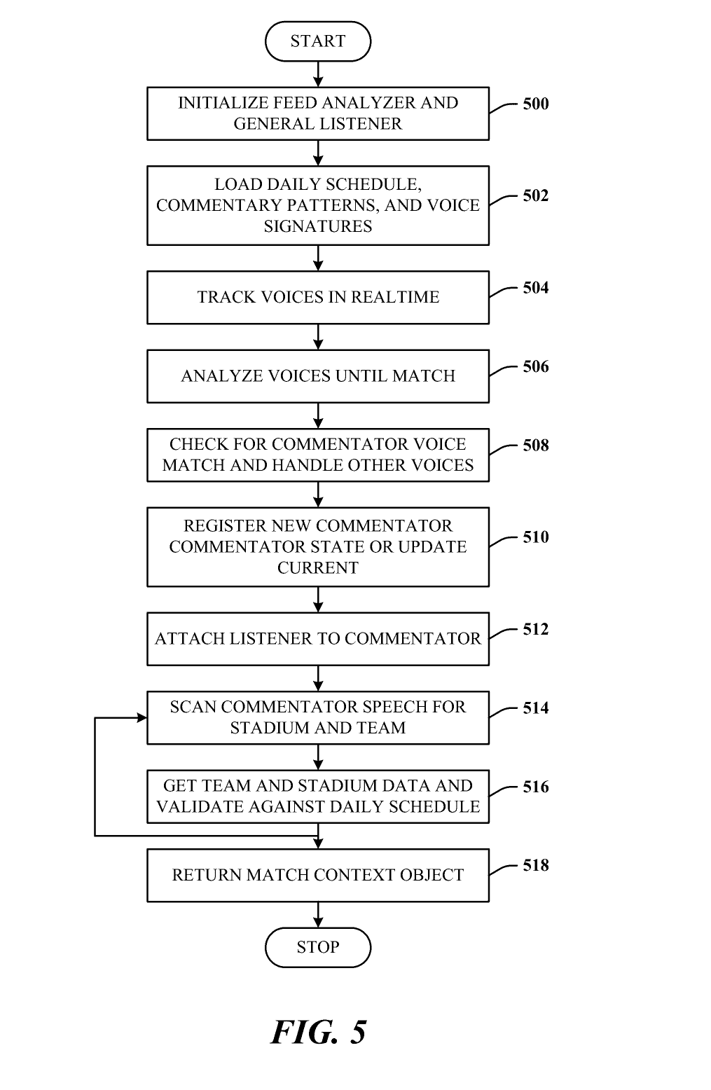

FIG. 5 illustrates a method of processing entity matches in accordance with the disclosed architecture. This method relates specifically to a live broadcast feed of a sporting event; however, flow can also apply to a non-live media presentation. At 500, flow begins by initializing a live feed analyzer and general listener in preparation for signal analysis of the media presentation. At 502, daily sports schedule, commentary patterns and voice signatures are loaded for the analyzer and listener. At 504, voice signals from the live feed are tracked in real-time. At 506, the voice signals are analyzed for a match to voice patterns. A prime objective of the voice analysis and pattern matching is to separate the commentator from the “normal, in-room voices”. That is, if the commentator is identified, the remaining voices are handled from a different thread in order to capture sentiments while the main thread focuses on the commentator(s) in order to identify the entities mentioned and the progress of the match/event. At 508, a check is made for commentator voice matches; if no commentator matches are found, continue to process the voice signals of other people who are speaking.

At 510, any new commentators are determined and registered, and existing commentators are state updated. In either case, a listener thread is attached to the given identified commentator, as indicated at 512. At 514, the commentator phrases are scanned for sport, league, stadium, location, teams, player names, and related information. At 516, when the stadium and teams information is suspected of being found, it is compared against the daily schedule of sporting events information. If successfully verified, context object is returned for this sporting event, as indicated at 518. If not successfully verified, flow returns back to 514, to continue scanning commentator speech for stadium and team information for another verification check and a successful verification.

In a more general description related to sporting events, as a user watches a live sporting event on the television (radio, laptop, or on any similar user device), the disclosed client application is capable of understanding if the user is watching a sporting event, the specific sporting event being watched, if the sporting event is live or not, the stadium, the sport to which the competition refers, the teams playing and team synthesis, the activities defined for the specific sport and the related terminology, and event metadata such as, duration, sport-related terminology, etc.

During the live match description, the client application 308 component can identify each specific activity/moment (e.g., a goal, free kick, penalty, etc., in the context of a soccer game), and also identify the involved players and the affected team. Each activity/moment instance (combining its type, involved players, teams etc.) triggers a process of building an optimal metadata package, which comprises an additional, non-standard package of information for the player and/or team (e.g., can be a combination of player biography, recent news, popular social posts, and more, along with internal data from the sports ecosystem.

As users watch the live sporting event, the user device(s) seamlessly synchronize and then present the highly-relevant package of metadata in real-time or a near real-time fashion and according to an optimized timing effect. The overall experience is also optimized for the specific user through a continuous, multi-stage optimization process, which can operate to identify the given user of a device and customize (personalize) the experience specifically to the given user by serving content of interest only to the given user.

In the “voice input” scenario, the client application 308 “listens” to the person or persons describing the sporting event, and identifies the sporting event itself, the player names, significant events (e.g., goal, penalty, etc.), and then performs text matching, applies a background search, and presents a highly-related synthesis of statistics, information, and content to the user, on a different user device.

In the live commentary scenario, the client application 308 can apply natural language processing (NLP) on the live commentary feed (as possibly provided by a third party and integrated as additional signal(s)), again performing entity extraction and metadata retrieval (e.g., voice and live commentary inputs can be handled in parallel to provide accuracy and flexibility). The combination uses both sources of live match event information in order to deliver the most appropriate and timely user experience.

In a more detailed description related to sporting events, for example, in an initial phase of identifying the commentator(s), the sporting event and associated key entities (entities that are considered to be highly relevant to the sporting event such as principal players, coaches, field name, city location, team name, etc., and thus are considered as indicators to other entities or aspects thereof that are to be identified), the user can initiate the client application 308 or the client application 308 automatically wakes up based on some trigger signal and/or data. The client application 308 initiates or resumes the general listener and the feed analyzer. The client application 308 loads the daily sports schedule, across sports and leagues, in the current market or in multiple markets, according to specific user habits and/or preferences.

The client application 308 loads a sports and events index, a sports player index, and a sports stadium index. The client application 308 loads commentary patterns and voice signatures for registered (known) commentators. The client application 308 attempts identification of the commentator by comparing with the known commentator voice signatures and commentary patterns. For each identified commentator voice signature, there is an entry in the knowledge base, cumulatively listing all popular commentators for a sport and for a given market.

The general listener starts analyzing speech and ongoing discussions to distinguish the announcer(s)/commentator(s) from any other person talking, and to then use the identified entities (people) to further identify the game/match and activities/moments of the game/match, as well as capture sentiment. The general listener separates voices and organizes the separated voices into a set of voice threads. Each sound, word, and sentence identified is matched against voice threads and allocated to the best matching thread. As soon as a voice-thread is sufficiently rich, the general listener looks for speech patterns that match the specific patterns of a formal sports match/event commentator. If the voice thread is identified as belonging to a sporting event commentator, the game listener is attached to the voice thread, separating all other voices thereafter.

The client application 308 sends updates on the identified commentator to a server. Voice threads belonging to non-commentators are used for post-processing and sentiment analysis. If no pre-registered commentator is identified, the client application 308 attempts identification of an unknown commentator, if any, using the general commentary patterns. The patterns can comprise a specific style, structure, speed and flow of words regarding commentary, intonations (variations of spoken pitch, loudness, tempo, rhythm, etc.) of the speech, which may be in contrast to normal speech/discussions. This overall style—expected structure/speed, etc.—can be also used to identify an unknown/unregistered commentator. If the sports commentator is known, statistics are updated in the knowledge base; otherwise, a new sports commentator entry is created and gradually enriched.

As soon as a known (registered) or new commentator is identified, a dedicated game listener is initiated. The client application 308 scans the commentator phrases targeting specific stadium, sport, leagues, teams, player names, and events. Provided with an identification of any sufficient combination of stadium, the teams, specific player names, and events, the system is able to determine the match, with some degree of confidence.

As soon as the match is identified, the client application 308 retrieves live match metadata, including the teams, the players, the league, the exact starting/ending times. A check is made for live commentary (text feed which may be provided by a third party) available for the match; if available, the feed can be established. The match is then flagged and information is sent to the server, to be used by other instances.

In a more detailed description related to sporting events, for example, and to the process of identifying entities and events, and presenting player (and other) facts to the user, the client application 308 knows the commentator at this point, and the match has been identified. The client application 308 asks the server if there is any already-registered, high-quality match/game listener available. If so, the client application 308 subscribes to the best available game listener, and simply consumes its events. If there is no sufficient game listener available, the client application 308 starts listening. Having identified a game, the client application 308 loads the detailed sport-specific dictionary with the exact definition of events and associated frequencies, and the typical phrases used in describing games of this sport.

The client application 308 then loads detailed event patterns and rules for the identified sport, loads detailed team synthesis for the identified teams, and loads detailed information about the stadium, referees, and other key-entities involved (depending on the sport).

For each word or block of words captured and identified as belonging to a given commentator, the client application 308 attempts a match against sports-and-events index definitions, a sports player index, and a stadium index. Each word is either allocated to the corresponding dictionary or placed into the corresponding user dictionary. It is placed in a domain dictionary, depending on if the stadium, player, sport/event the word is characterized as such and added to the live games dictionary.

For each word or block of words captured and identified as belonging to a given commentator, if it is an event, the event is added to a game log and visualized. If the event is significant, the most related entity (usually a player), the mentioned entity, as called out before and just after the event, is captured. If the quality and confidence in the identification process is outstanding (according to some quality threshold), the event information is submitted to the server, as a candidate master event and master public listener.

In a more detailed description related to sporting events, for example, and to the process of compiling a content mix for a user, content display history is checked for the mentioned entity regarding the current user and event. Additionally, metadata for the mentioned entity is checked against the preconfigured data sources, and the next best package of content for the mentioned entity is displayed, thereby increasing the probability that displayed player content remains fresh and of interest to the user.

A next instance of content mix is then created for a specific mentioned entity, as a progressive step, and with continuity. The package of metadata served in the game content-mix history is then logged. If there are more than x seconds with no activity, the client application 308 may use team and stadium content along with highlights/moments from the game in order to fill the time gap.

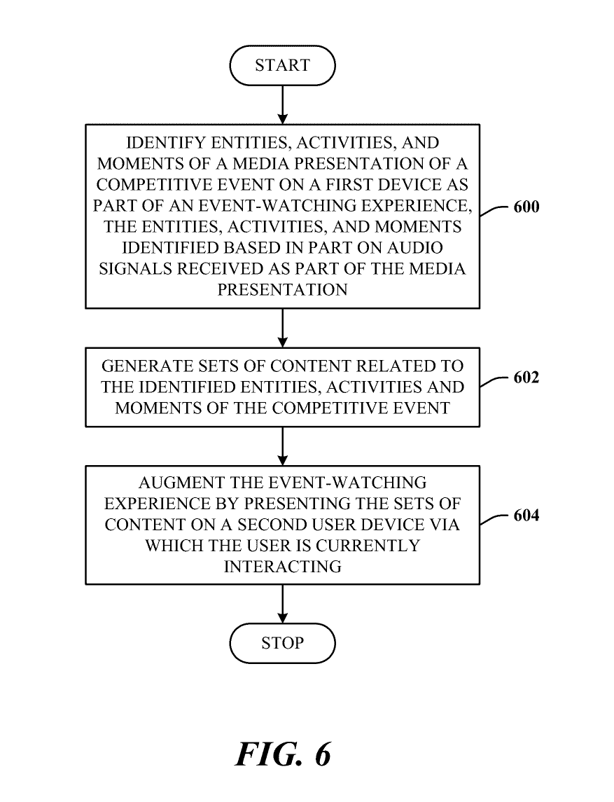

FIG. 6 illustrates an alternative method of processing entity matches in accordance with the disclosed architecture. At 600, entities, activities, and moments of a media presentation of a competitive event on a first device, are identified as part of an event-watching experience, the entities, activities, and moments identified based in part on audio signals received as part of the media presentation. At 602, sets of content related to the identified entities, activities and moments of the competitive event are generated. At 604, the event-watching experience is augmented by presenting the sets of content on a second user device via which the user is currently interacting.

The method can further comprise automatically identifying the competitive event free of any input from the user. The method can further comprise automatically identifying a speaking entity of the competitive event based on at least one of natural language processing and speech pattern analysis on voice signals or textual data recognized as part of the competitive event. The method can further comprise identifying a previously-unknown commentator of the competitive event based on analysis of style, structure, speed and flow of words of the previously-unknown commentator. The method can further comprise updating the sets of content based on changes in the activities and the entities of the competitive event.

The method can further comprise synthesizing a set of personalized content personalized to the user and presenting the set of personalized content to the user on the second user device via which the user is currently interacting. The method can further comprise analyzing user discussions as relate to the competitive event, and identifying sentiment levels about the competitive event, specific moments of the competitive event, teams, and associated team entities. The method can further comprise updating the sets of content based on the user discussions and sentiment levels.

The method can further comprise creating event-related virtual rooms as part a live feed of the competitive event and for user discussions related to the competitive event. The method can further comprise continually updating composition of the sets of content for a given user based on corresponding changes in at least one of implicit preferences and behaviors or explicit preferences and behaviors of the user during the competitive event.

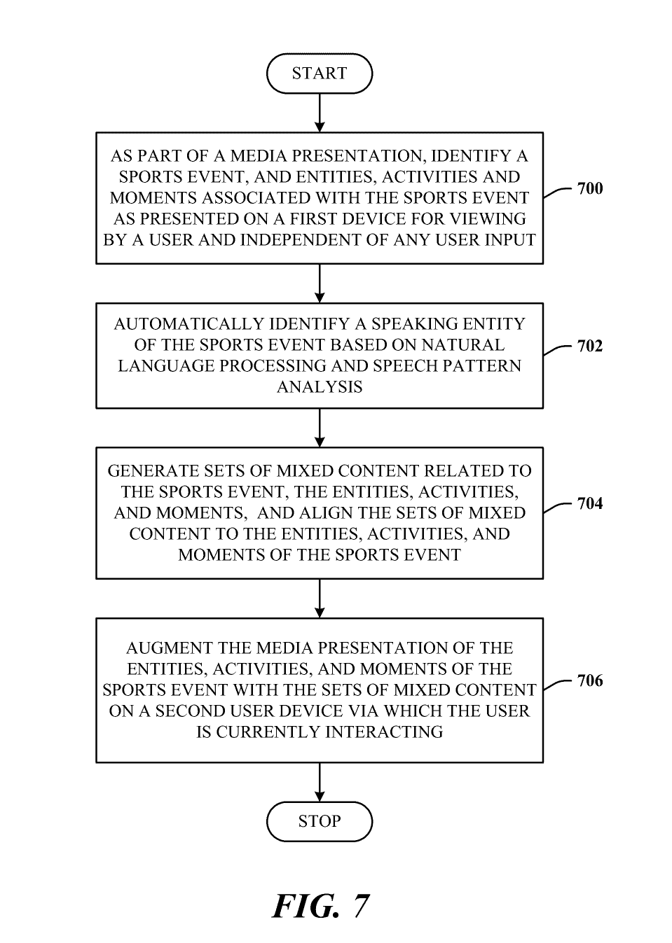

FIG. 7 illustrates an alternative method in accordance with the disclosed architecture. At 700, as part of a media presentation, identify a sports event, and entities, activities, and moments associated with the sports event as presented on a first device for viewing by a user and independent of any user input. At 702, a speaking entity of the sports event is automatically identified based on natural language processing and speech pattern analysis. At 704, sets of mixed content related to the sports event, the entities, activities, and moments are generated, and the sets of mixed content are aligned to the activities, moments, and entities of the sports event. At 706, the media presentation of the entities, activities, and moments of the sports event is augmented with the sets of mixed content on a second user device via which the user is currently interacting.

The method can further comprise updating the sets of mixed content based on changes in the entities, activities, and moments of the sports event. The method can further comprise synthesizing a set of personalized content personalized to the user and presenting the set of personalized content to the user on the second user device via which the user is currently interacting.

The method can further comprise continually updating composition of the sets of mixed content for a given user based on corresponding changes in at least one of implicit preferences and behaviors of the user or explicit preferences and behaviors of the user during the sports event.

As used in this application, the term “component” is intended to refer to a computer-related entity, either hardware, a combination of software and tangible hardware, software, or software in execution. For example, a component can be, but is not limited to, tangible components such as one or more microprocessors, chip memory, mass storage devices (e.g., optical drives, solid state drives, magnetic storage media drives, etc.), computers, and portable computing and computing-capable devices (e.g., cell phones, tablets, smart phones, etc.). Software components include processes running on a microprocessor, an object (a software entity that maintains state in variables and behavior using methods), an executable, a data structure (stored in a volatile or a non-volatile storage medium), a module (a part of a program), a thread of execution (the smallest sequence of instructions that can be managed independently), and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

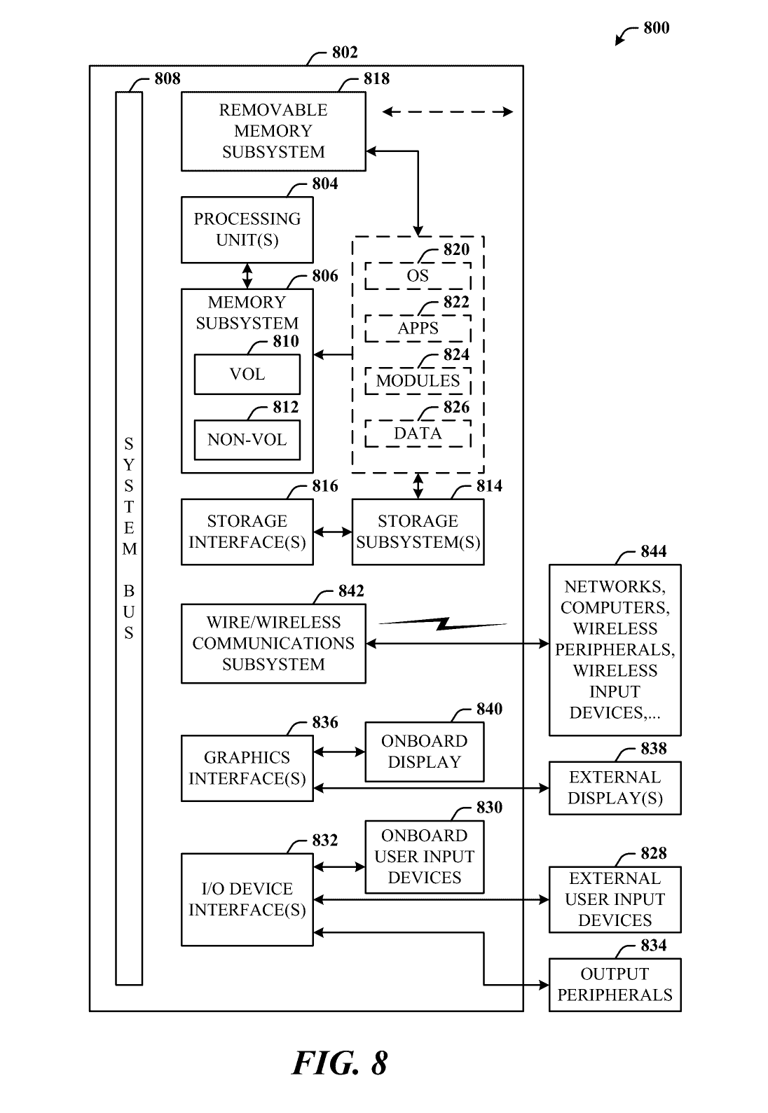

Referring now to FIG. 8, there is illustrated a block diagram of a computing system 800 that executes an augmented experience of media presentation events in accordance with the disclosed architecture. Alternatively, or in addition, the functionally described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc., where analog, digital, and/or mixed signals and other functionality can be implemented in a substrate.

In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel implementation also can be realized in combination with other program modules and/or as a combination of hardware and software.

The computing system 800 for implementing various aspects includes the computer 802 having microprocessing unit(s) 804 (also referred to as microprocessor(s) and processor(s)), a computer-readable storage medium (where the medium is any physical device or material on which data can be electronically and/or optically stored and retrieved) such as a system memory 806 (computer readable storage medium/media also include magnetic disks, optical disks, solid state drives, external memory systems, and flash memory drives), and a system bus 808. The microprocessing unit(s) 804 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 802 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 806 can include computer-readable storage (physical storage) medium such as a volatile (VOL) memory 810 (e.g., random access memory (RAM)) and a non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the microprocessing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components and circuits. The storage subsystem(s) 814 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The operating system 820, one or more application programs 822, other program modules 824, and/or program data 826 can include items and components of the system 100 of FIG. 1, items and components of the system 200 of FIG. 2, items and components of the system 300 of FIG. 3, items and components of the system 400 of FIG. 4, and the methods represented by the flowcharts of FIGS. 5-7, for example.

Generally, programs include routines, methods, data structures, other software components, etc., that perform particular tasks, functions, or implement particular abstract data types. All or portions of the operating system 820, applications 822, modules 824, and/or data 826 can also be cached in memory such as the volatile memory 810 and/or non-volatile memory, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 802, and include volatile and non-volatile internal and/or external media that is removable and/or non-removable. For the computer 802, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 802, programs, and data using external user input devices 828 such as a keyboard and a mouse, as well as by voice commands facilitated by speech recognition. Other external user input devices 828 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 802, programs, and data using onboard user input devices 830 such a touchpad, microphone, keyboard, etc., where the computer 802 is a portable computer, for example.

These and other input devices are connected to the microprocessing unit(s) 804 through input/output (I/O) device interface(s) 832 via the system bus 808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

The disclosed architecture can be implemented as a system, comprising: means for identifying entities, activities, and moments of a media presentation of a competitive event on a first device as part of an event-watching experience, the entities, activities, and moments identified based in part on audio signals received as part of the media presentation; means for generating sets of content related to the identified entities, activities, and moments of the competitive event; and, means for augmenting the event-watching experience by presenting the sets of content on a second user device via which the user is currently interacting.

The disclosed architecture can be implemented as an alternative system, comprising: as part of a media presentation, means for identifying a sports event, and entities, activities, and moments associated with the sports event as presented on a first device for viewing by a user and independent of any user input; means for automatically identifying a speaking entity of the sports event based on natural language processing and speech pattern analysis; means for generating sets of mixed content related to the sports event, the entities, activities, and moments, and aligning the sets of mixed content to the activities, the moments, and the entities of the sports event; and, means for augmenting the media presentation of the entities, activities, and moments of the sports event with the sets of the mixed content, as communicated to a second user device via which the user is currently interacting.

What has been described above includes examples of the disclosed architecture. It is, of course, not possible to describe every conceivable combination of components and/or methodologies, but one of ordinary skill in the art may recognize that many further combinations and permutations are possible.

Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an event identification component configured to listen and identify, from at least one of voice or textual signals of a media presentation, a sporting event and entities associated with the sporting event, the media presentation part of an event-watching experience for a user on a first user device;
a content generation component configured to generate sets of mixed content related to the sporting event, the entities, and implicitly indicated user preferences, and to synchronize the sets of mixed content with corresponding activities occurring as part of the sporting event, notable moments of the sporting event, and the entities of the sporting event;
an augmentation component configured to augment the event-watching experience of the media presentation with the sets of mixed content on a second user device via which the user is currently interacting; and
at least one hardware processor configured to execute computer-executable instructions in a memory, the instructions executed to enable the event identification component, the content generation component, and the augmentation component.

2. The system of claim 1, wherein the event identification component is configured to perform natural language processing and speech pattern analysis on speech signals of the media presentation of the sporting event and recognition of textual content to identify the entities.

3. The system of claim 1, wherein the event identification component is configured to identify participants in the sporting event.

4. The system of claim 1, wherein the event identification component is configured to identify a commentator of the sporting event, and from which commentator identification is derived additional information that includes participants, player and game moments, significant plays that occur during the sporting event and that impact outcome of the sporting event, and notable players.

5. The system of claim 1, wherein the content generation component is configured to access user display history as relates to the sporting event and choose a next set of mixed content to be served as complementary to the media presentation to the second user device based on user content consumption patterns and history.

6. The system of claim 1, further comprising a sentiment component configured to capture user sentiment during discussions of the activities occurring as part of the sporting event.

7. The system of claim 1, further comprising discussion component configured to generate virtual rooms and enable access to the virtual rooms for discussions related to the sporting event and the entities.

8. A method, comprising acts of:
identifying entities, activities, and moments of a media presentation of a competitive event on a first device as part of an event-watching experience, the entities, activities, and moments identified based in part on audio signals received as part of the media presentation;
generating sets of content related to the identified entities, activities, and moments of the competitive event; and
augmenting the event-watching experience by presenting the sets of content on a second user device via which the user is currently interacting.

9. The method of claim 8, further comprising automatically identifying the competitive event free of any input from the user.

10. The method of claim 8, further comprising automatically identifying a speaking entity of the competitive event based on at least one of natural language processing and speech pattern analysis on voice signals or textual data recognized as part of presentation of the competitive event.

11. The method of claim 8, further comprising identifying a previously-unknown commentator of the competitive event based on analysis of style, structure, speed and flow of words of the previously-unknown commentator.

12. The method of claim 8, further comprising synthesizing a set of content personalized to the user and presenting the set of personalized content to the user on the second user device via which the user is currently interacting.

13. The method of claim 8, further comprising analyzing user discussions as relate to the competitive event, and identifying sentiment levels about the competitive event, specific moments of the competitive event, teams, and associated team entities.

14. The method of claim 13, further comprising updating the sets of content based on the user discussions and sentiment levels.

15. The method of claim 8, further comprising creating event-related virtual rooms as part a live feed of the competitive event and for user discussions related to the competitive event.

16. The method of claim 8, further comprising continually updating composition of the sets of content for a given user based on corresponding changes in at least one of implicit preferences and behaviors or explicit preferences and behaviors of the user during the competitive event.

17. A method, comprising acts of:
as part of a media presentation, identifying a sports event, and entities, activities, and moments associated with the sports event as presented on a first device for viewing by a user and independent of any user input;
automatically identifying a speaking entity of the sports event based on natural language processing and speech pattern analysis;
generating sets of mixed content related to the sports event, the entities, activities, and moments and aligning the sets of mixed content to the activities, the moments, and the entities of the sports event; and
augmenting the media presentation of the entities, activities, and moments of the sports event with the sets of mixed content on a second user device via which the user is currently interacting.

18. The method of claim 17, further comprising updating the sets of content based on changes in the entities, activities, and moments of the sports event.

19. The method of claim 17, further comprising synthesizing a set of content personalized to the user and presenting the set of personalized content to the user on the second user device via which the user is currently interacting.

20. The method of claim 17, further comprising continually updating composition of the sets of mixed content for a given user based on corresponding changes in at least one of implicit preferences and behaviors of the user or explicit preferences and behaviors of the user during the sports event.
